(19) United States
(12) Patent Application Publication
(10) Pub. No.: US 2014/0175102 A1
(43) Pub. Date: Jun. 26, 2014

(54) SIDE ACCESSIBLE COOKING APPARATUS

(71) Applicant: Todd SMITH, Bellevue, WA (US)

(72) Inventor: Todd SMITH, Bellevue, WA (US)

(21) Appl. No.: 14/109,404

(22) Filed: Dec. 17, 2013

Related U.S. Application Data
(60) Provisional application No. 61/739,553, filed on Dec. 19, 2012.

(51) Int. Cl. A47J 36/06

(52) U.S. Cl. CPC A47J 36/06
USPC 220/573.1; 220/212.5

(57) ABSTRACT

An apparatus for cooking and preparing food that includes side accessibility. Such a cooking vessel includes advantages over conventional cooking vessels because the prepared food may be accessed from the side as opposed to accessing it from the top in conventional ovens and cooking vessels. Thus, a cooking vessel base may include a semi-enclosed cavity that has a flat base section with walls that leave exposed a side where food may be retrieved. Further, the apparatus includes a cooking vessel lid that may be placed on the cooking vessel base and enclose the exposed top and the exposed side. The shape of the cavity may be any shape where a portion of a lateral side may be accessed when the accompanying lid is removed. Such examples of shapes include a rectangular and a circular vessel.

### PRIORITY CLAIM

The instant application claims priority to U.S. Provisional Patent Application No. 61/739,553 filed Dec. 19, 2012, which application is incorporated herein by reference in its entirety.

### BACKGROUND

Various cooking devices, such as Dutch ovens and the like, are used the world over to prepare food both indoors and outdoors. In the case of a Dutch oven, a thick-walled (usually cast iron) cooking pot utilizes a tight-fitting lid to maintain heat in the inside for pressure or steam cooking. Dutch ovens have been used as cooking vessels for hundreds of years and have been used for making baked breads over campfires as well as many other uses.

However, when using a conventional Dutch oven, a user may retrieve the contents of the Dutch oven, (e.g., the food being prepared) after removing the lid and using one or more utensils to lift the food out the top of the Dutch oven. Such a retrieval process may be difficult for various breads being prepared as often the shape of the bread conforms to the interior of the cooking vessel when it is of a smaller size. That is, despite providing the ability to make breads and other traditional foods with a Dutch oven, the need to lift the food out of the top of the cooking vessel tends to make such food preparation more difficult and cumbersome.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 shows an isometric diagram an embodiment of a base portion of a side-accessible cooking apparatus according to an embodiment of the subject matter discussed herein.

FIG. 2 shows an isometric diagram an embodiment of a lid portion of a side-accessible cooking apparatus according to an embodiment of the subject matter discussed herein.

FIG. 3 shows an isometric diagram an embodiment of a base portion of a side-accessible cooking apparatus having a cooking rack according to an embodiment of the subject matter discussed herein.

FIG. 4 show another embodiment of a side-accessible cooking apparatuses according to an embodiment of the subject matter discussed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein is related to an apparatus for cooking and preparing food that includes side accessibility. Such a cooking vessel includes advantages over conventional cooking vessels because the prepared food may be accessed from the side as opposed to accessing it from the top in conventional ovens and cooking vessels. Thus, a cooking vessel base may include a semi-enclosed cavity that has a flat base section with walls that leave exposed a side where food may be retrieved. Further, the apparatus includes a cooking vessel lid that may be placed on the cooking vessel base and enclose the exposed top and the exposed side. As discussed further below, the shape of the cavity may be any shape where a portion of a lateral side may be accessed when the accompanying lid is removed. Such examples of shapes include a rectangular and a circular vessel.

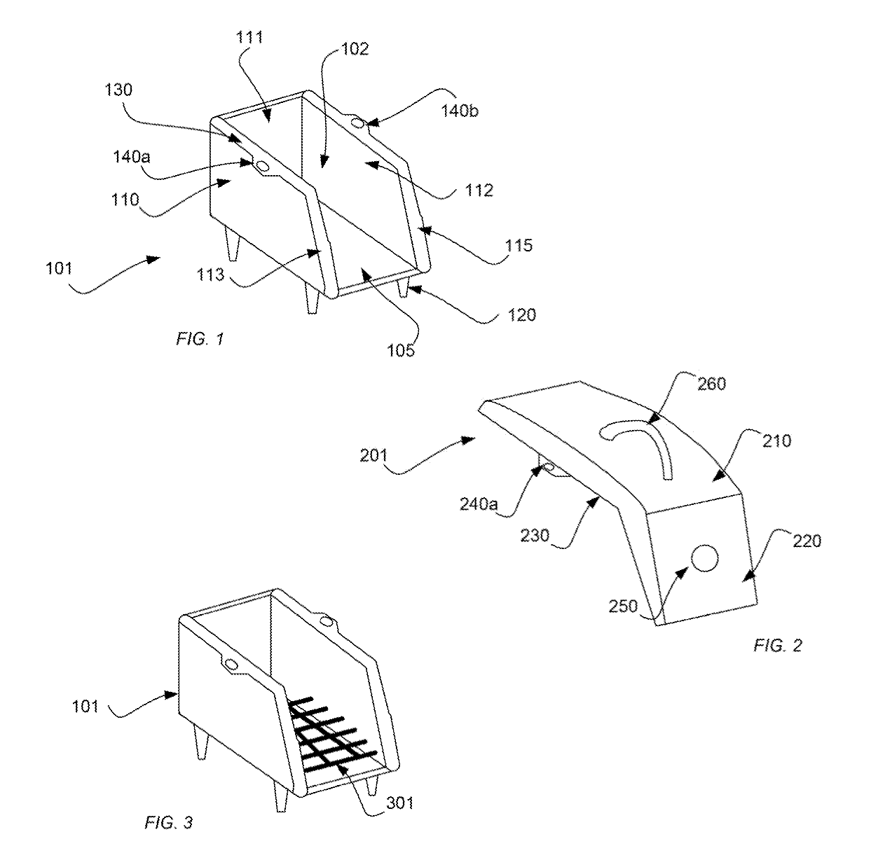

The side-accessible cooking apparatus is a unique design of cookware that may be used for cooking artisan bread and all types of outdoor cooking. With such a base portion with a covering lid, the side-accessible cooking vessel allows for all the benefits of a traditional roasting pan or Dutch oven cooking but with the advantage of have side access. The lid creates a closed and sealed container, but when removed allows the base portion to have side access for removing prepared foods easily from the vessel. The side access also allows the base portion to be used as a griddle or fry pan. Further, the lid has a rim for holding coals when outdoor cooking in much the same way a traditional Dutch oven can hold the coals on the lid. The base portion is designed with legs to stand above coals when cooking outdoors. Other embodiments do not have legs for use inside a traditional oven. These and other advantages are discussed with respect to FIGS. 1-4.

FIG. 1 shows an isometric diagram an embodiment of a base portion 101 of a side-accessible cooking apparatus according to an embodiment of the subject matter discussed herein. This embodiment includes a flat base section 105 flanked by first, second and third side walls 110, 111, and 112 that extend up from the base section 105. Here, as shown, the side walls are positioned as a back wall 111 and left 110 and right 112 side walls. Left and right are designated with respect to an opening 115 at the fourth side. Thus, this leaves exposed the front side 115, which may the side that provides accessibility to the interior cooking space of a vessel 102. The left and right sidewalls 110 and 112 may also have angled ends such that each end 113 and 115, respectively forms an angle between 60 and 90 degrees with respect to the base section 105.

The base portion 101 may include legs 120 for positioning the vessel above coals in a campfire. The legs 120 may be integral with the base portion 101 or may be removably attached such that the base portion 101 may lie flat on an oven rack.

Further, the base portion 101 includes a lip 130 that is contiguous with the three side walls 110, 111, and 112 on the top of these side walls. The lip 130 provides a suitable engagement surface for a lid portion 201 as shown and discussed with respect to FIG. 2. The lip 130 may include engagement flanges 140a and 140b having holes or protrusions for clamping the lid portion (not shown in FIG. 1) to the base portion 101 such that pressure may be mainlined inside the vessel 102. The base portion 101 of FIG. 1 may be configured to be engaged with a lid portion 201 as discussed next with respect to FIG. 2.

FIG. 2 shows an isometric diagram an embodiment of a lid portion 201 of a side-accessible cooking apparatus according to an embodiment of the subject matter discussed herein. The lid portion 201 may be suited to engage with the base portion 101 (FIG. 1) to enclose a cooking vessel of the overall side-accessible cooking apparatus. Generally, the lid portion 201 includes a top section 210 and a lower section 220 attached to the top section 210 protruding downward from the top section 210. The lower section 220 may be attached to the top section 210 at an angle between 60 and 120 degrees suited to match with the angel of the ends of the sidewalls 110 an 112 of the base portion 101.

The lid portion 201 may include a counterpart lip 230 suited to interface with the lip 130 of the base portion 101 such that the cooking vessel 102 becomes an enclosed cavity. Further, the lid portion 201 may also include engagement flanges 240a having holes or protrusions suited to allow the lid portion 201 to be clamped to the base portion 101 for higher pressure cooking. As shown, the base portion 101 of FIG. 1 and the lid portion 201 are designed to fit together to form a rectangular cooking vessel enclosed by the bottom portion 101 and the lid portion 201.

In other embodiments, the lid portion 201 may include a second lower section in conjunction with the base portion 101 also having one less side wall such that the base portion 101 and lid portion 201 still form an enclosed cavity for cooking. Any combination of side walls disposed between the lid portion 201 and the base portion 101 may be realized such that as long as one side remains accessible when the lid portion 201 is removed. Thus, a cooking apparatus may be realized that includes a first portion (e.g., bottom portion 101) and a second portion (e.g., lid portion 201) configured to be attached to each other along a boundary between the first and second portions such that a vessel is enclosed by the first and second portions. This boundary may then comprise any number of sections that are disposed across different planes. Thus, at least a first section disposed in a first plane (e.g., the top side plane of the top section 210 of the lid portion 201) and a second section disposed in a second plane (e.g., the lower section 220 plane).

The lid portion 201 may further include an access hole 250 disposed in a lower section 220 which allows steam to be injected into the sealed cooking vessel. This step of injecting steam into the sealed cooking space may be used in artisan baking. This design and steam injection ability allows the home enthusiast to get the same results as is found in artisan bakeries and other professional ovens. Further the lid portion 201 may also include a handle 260 for easily lifting the lid portion 201.

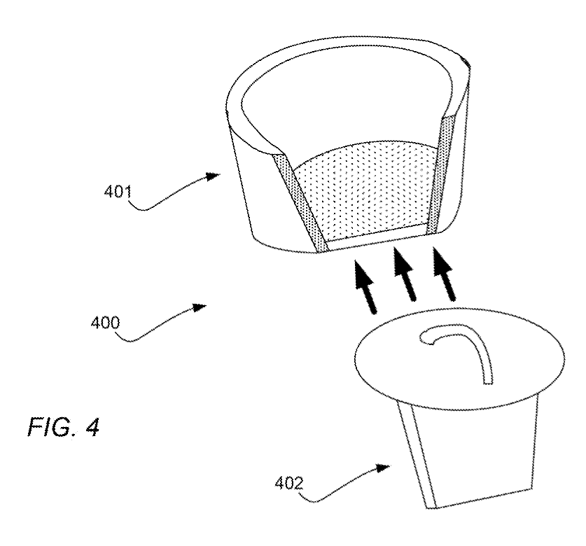

FIG. 3 shows an isometric diagram an embodiment of a base portion 101 of a side-accessible cooking apparatus having a cooking rack 301. There are a number of accessories that may go along with the side-accessible cooking apparatus. Such accessories may include Insert pans, racks, spatulas, wooden peels (for removing bread, pizza, etc.), water injectors, hot pads, lid lifters, etc. Not all accessories are shown in the figures.

FIG. 4 shows an additional embodiment of a side-accessible cooking apparatus. This embodiment includes a circular vessel base portion 401 suited to engage a circular lid portion 402. Together, the side-accessible cooking apparatus 400 may be better suited for different uses, such as bread baking for round-shaped bread and the like.

For indoor use inside a standard kitchen oven, the various embodiments of the side-accessible cooking apparatus may be the ideal artisan bread and baking pan. For outdoor use over coals or an open fire, it is an oven that combines the many sizes and styles of Dutch ovens into one unique pan which can be used for baking, frying, grilling, boiling, stewing, etc. The apparatuses may be formed from cast iron or lighter aluminum or may be formed from any material suitable for withstanding higher temperatures in a cooking environment.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A cooking device, comprising:
a base portion having a vessel defined by a bottom wall and side walls such that an opening on a top side and at least a portion of one side wall of the vessel remain exposed;
a cover portion configured to engage the bottom portion to cover the opening.

2. The cooking device of claim 1, further comprising a substantially rectangular base portion and a substantially rectangular cover portion.

3. The cooking device of claim 1, further comprising a substantially circular base portion and a substantially circular cover portion.

4. The cooking device of claim 1, wherein the sidewalls are substantially perpendicular to the bottom side of the base portion.

5. The cooking device of claim 1, wherein the sidewalls further comprise a lip configured to engage the lid portion.

6. The cooking device of claim 5, wherein the lip further comprises flanges having holes configured for engaging a securing mechanism to secure the lid portion to the bottom portion.

7. The cooking device of claim 1, wherein the top portion further comprises a lip configured to engage the bottom portion.

8. The cooking device of claim 7, wherein the lip further comprises flanges having holes configured for engaging a securing mechanism to secure the lid portion to the bottom portion.

9. The cooking device of claim 1, wherein the vessel is sealed to provide a pressurized cavity when the lid portion is engaged with the bottom portion.

10. The cooking device of claim 1, wherein the lid portion further comprises a handle disposed on a top side of the lid portion.

11. The cooking device of claim 1, wherein the bottom portion further comprises removable feet disposed on the bottom wall of the bottom portion.

12. The cooking device of claim 1, wherein the bottom portion further comprises a removable cooking rack.

13. The cooking device of claim 1, wherein the opening of the side walls of the bottom portion comprises an angle with respect to the bottom wall of substantially 60 to 120 degrees.

14. The cooking device of claim 1, wherein the lid portion comprises a top section and a lower section such that the lower section is attached to the top section at an angle of substantially 60 to 120 degrees.

15. The cooking device of claim 1, wherein the lid portion further comprises an access hole disposed in the lower section configured to allow steam to be injected into the vessel.

16. A cooking apparatus, comprising:
a first portion; and
a second portion configured to be attached to the first portion along a boundary between the first and second portions such that a vessel is enclosed by the first and second portion;
wherein the boundary further comprises a first section disposed in a first plane and a second section disposed in a second plane.

17. The cooking apparatus of claim 16, wherein the first plane is disposed substantially between 60 and 120 degrees with respect to the second plane.

18. The cooking apparatus of claim 16, further comprising a substantially rectangular first portion and a substantially rectangular second portion.

19. The cooking apparatus of claim 16, further comprising a substantially circular first portion and a substantially circular second portion.

20. The cooking apparatus of claim 16, wherein at least the first or second section further comprises an access hole configured to allow steam to be injected into the vessel.
